(19) United States
(12) Patent Application Publication
(10) Pub. No.: US 2009/0153739 A1
(43) Pub. Date: Jun. 18, 2009

(54) Method and Apparatus for a Noise Filter for Reducing Noise in a Image or Video

(75) Inventor: Wei Hong, Richardson, TX (US)

Correspondence Address: TEXAS INSTRUMENTS INCORPORATED, P O BOX 655474, M/S 3999, DALLAS, TX, 75265, US

(73) Assignee: TEXAS INSTRUMENTS INCORPORATED, Dallas, TX (US)

(21) Appl. No.: 12/333,515

(22) Filed: Dec. 12, 2008

Related U.S. Application Data
(60) Provisional application No. 61/013,682, filed on Dec. 14, 2007.

(51) Int. Cl. H04N 5/00

(52) U.S. Cl. 348/620

(57) ABSTRACT

A noise filter method and apparatus for producing at least one of a video or an image with reduced noise. The noise filter method includes performing noise estimation on a frame of at least one of an image or video and applying a low pass filter on the noise level according to the noise estimation, performing spatial filtration on the frame, performing motion detection on a spatially filtered frame, determining motion-to-blending factor conversion and, accordingly, performing frame blending, and outputting a frame with reduced noise.

### CROSS-REFERENCE TO RELATED APPLICATIONS

This application claims benefit of U.S. provisional patent application Ser. No. 61/013,682, filed Dec. 14, 2007, which is herein incorporated by reference.

### BACKGROUND OF THE INVENTION

1. Field of the Invention

Embodiments of the present invention generally relate to a method and apparatus for a noise filter for reducing noise in a noisy image or video.

2. Description of the Related Art

Video and image noise reduction is an important part of video and image processing in both input side and display side of digital consumer electronics. For example, videos captured by digital camcorders, cameras, and video cellular phones under low-light and high ISO gain contain significant amount of noise. Analog video inputs from TV cable and DVD/VCR are also contaminated by transmission noise. The noise not only degrades the video quality, but also hurts the video coding efficiency because the encoder has to spend extra bits to encode the noise.

Therefore, there is a need for a method and/or apparatus for an improved noise filter that reduces noise in a noisy image or video.

### SUMMARY OF THE INVENTION

Embodiments of the present invention relate to a noise filter method and apparatus for producing at least one of a video or an image with reduced noise. The noise filter method includes performing noise estimation on a frame of at least one of an image or video and applying a low pass filter on the noise level according to the noise estimation, performing spatial filtration on the frame, performing motion detection on a spatially filtered frame, determining motion-to-blending factor conversion and, accordingly, performing frame blending, and outputting a frame with reduced noise

### BRIEF DESCRIPTION OF THE DRAWINGS

So that the manner in which the above recited features of the present invention can be understood in detail, a more particular description of the invention, briefly summarized above, may be had by reference to embodiments, some of which are illustrated in the appended drawings. It is to be noted, however, that the appended drawings illustrate only typical embodiments of this invention and are therefore not to be considered limiting of its scope, for the invention may admit to other equally effective embodiments.

FIG. 1 an embodiment of a block diagram of a noise filter utilizing both spatial filtration and temporal filtration;

FIG. 2 is an embodiment of a blending factor controlled by the motion value

FIG. 3 is an embodiment of an offset α₀ is controlled by the total noise level Nₜₒₜₐₗ;

FIG. 4 is a flow diagram depicting an embodiment of a method for filtering noise utilizing both spatial filtration and temporal filtration; and

FIG. 5 is a flow diagram depicting an embodiment for generating a spatially filtered frame; and

FIG. 6 is a flow diagram depicting an embodiment for noise estimation.

### DETAILED DESCRIPTION

For the purposes of this application, a computer readable medium is any medium that may be accessed by a computer for reading, writing, executing, and the like of data and/or computer instructions.

Described herein is a noise filter for video or images that utilizes both spatial filtration and temporal filtration to effectively reduce the noise in noisy videos or images. The filter is adaptive to motion and noise level to achieve constantly good results for moving scenes and videos with changing noise level. The noise filter improves both visual quality and coding efficiency significantly. Even though this application describes the spatial filtration first, the noise estimation may be performed before or simultaneously.

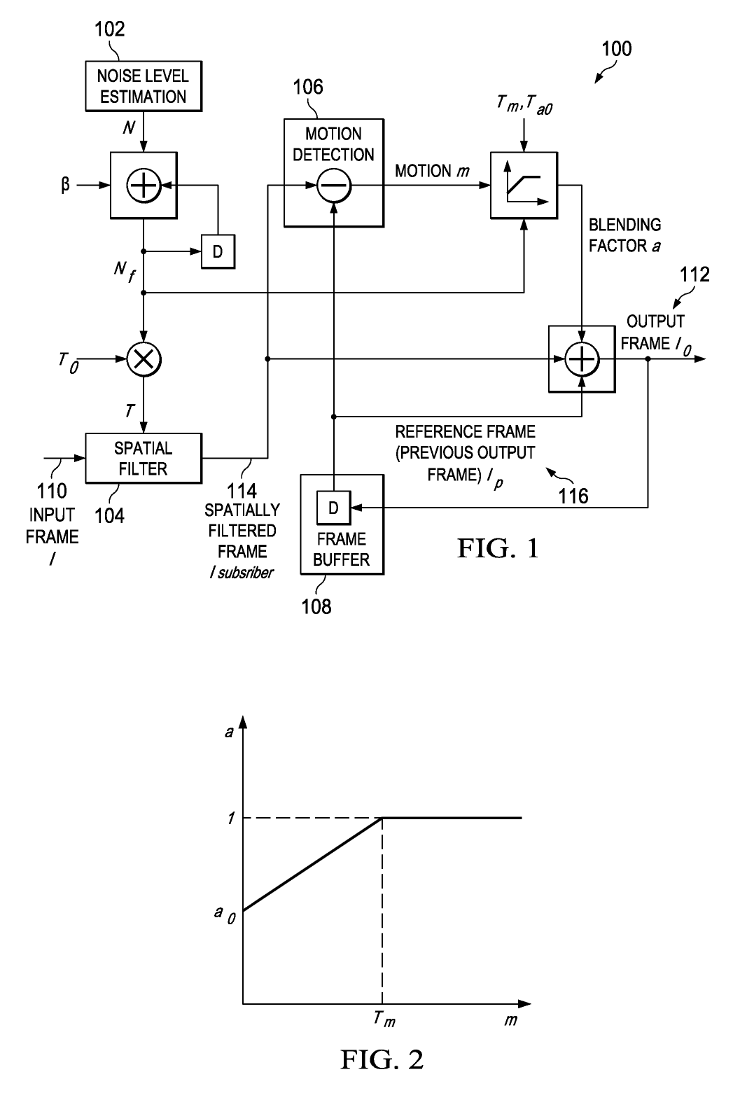

FIG. 1 an embodiment of a block diagram of a noise filter 100 utilizing both spatial filtration and temporal filtration. The noise filter includes a noise level estimation 102, a spatial filter 104, a motion detection 106, a buffer 108.

I(x,y,n) is the input frame 110 and Iₛ(x,y,n) is the output frame 114 of the spatial filter 104.

Iₛ(x,y,n)=Fₛ(I(x,y,n)).

The spatial filter Fₛ, of the spatial filter 104 may be applied block-by-block or line-by-line. The spatial filter Fₛ, involves three steps, which are discussed below. Note that the steps described may occur in different order.

First is the creation of a hierarchical representation. Hence, an h×v-level (horizontally h-level, vertically v-level) hierarchical representation is created of each frame by successive high-pass and low-pass filtration. The representation is a set of coefficient arrays in every level.

For k-th level, the high-pass filter and low-pass filter are:

f_{L}=[1(2^{k-1}−1)zeros 1], f_{H}=[1(2^{k-1}−1)zeros−1].

Without loss of generality, we assume h≧v. Let I₁=I. Starting from level 1, for the levels 1≦k≦v, apply the filters in the following way:
Filter Iₖ vertically by f_{L} to create vLₖ.
Filter Iₖ vertically by f_{H} to create vHₖ.
Filter vLₖ horizontally by f_{L} to create Iₖ₊₁.
Filter vLₖ horizontally by f_{H} to create vLhHₖ.
Filter vHₖ horizontally by f_{L} to create vHhLₖ.
Filter vHₖ horizontally by f_{H} to create vHhHₖ.
   For the levels v<k≦h, apply the filters in the following way:
Filter Iₖ horizontally by f_{L} to create Iₖ₊₁.
Filter Iₖ horizontally by f_{H} to create hHₖ.

For different system complexity constraints, we can choose different h and v to create spatial filter Fₛ, of the spatial filter 104 with different size. For example, if h and v are both 3, the size of Fₛ, is 15×15. If h=3 and v=2, the size of Fₛ, is 15×7. If h=2 and v=1, the size of Fₛ, is 7×3.

Second is the modification of the hierarchical representation. In this step, certain coefficient arrays in k-th level of the hierarchical representation are modified. For levels 1≦k≦v, vLhHₖ, vHhLₖ, vHhHₖ need to be modified. For levels v<k≦h, hHₖ need to be modified. For each of these coefficient arrays that need to be modified, we modify all the elements in them by using the following mapping function:

$$\begin{matrix}y = x for x \geq {T}_{k} , \\ = 0 for x < {T}_{k} .\end{matrix}$$

Tₖ is the threshold of k-th level which is a scaled version of the noise level N_{f} which will be determined by the noise estimation part.

Tₖ=T₀ₖN_{f}.

T₀ₖ is an input strength parameter of the k-th level of the spatial noise filter. Larger T₀ₖ produces smoother results. Smaller T₀ₖ keeps more details. The spatial noise filter for frame n can use Tₖ(n−1) if Tₖ(n) may not available before finishing processing frame n.

Third is the creation of a spatially filtered frame 114, in which modified hierarchical representation is used to create the spatially filtered frame 114. For k-th level, the high-pass filter and low-pass filter are:

f_{L}=[1(2^{k-1}−1)zeros 1],f_{H}=[−1(2^{k-1}−1)zeros 1].

Starting from level h, for the levels v<k≦h, the filters are applied in the following way:
Filter Iₖ₊₁ horizontally by f_{L} to create hLhLₖ.
Filter hHₖ horizontally by f_{H} to create hHhHₖ.
Iₖ=(hLhLₖ+hHhHₖ)/4.
   For the levels 1≦k≦v, apply the filters in the following way:
Filter Iₖ₊₁ vertically by f_{L} to create vLhLvL_{k.}
Filter vLhLvLₖ horizontally by h_{L} to create vLhLvLhLₖ.
Filter vLhHₖ vertically by f_{L} to create vLhHvLₖ.
Filter vLhHvLₖ horizontally by h_{H} to create vLhHvLhHₖ.
Filter vHhLₖ vertically by f_{H} to create vHhLvHₖ.
Filter vHhLvHₖ horizontally by h_{L} to create vHhLvHhLₖ.
Filter vHhHₖ vertically by f_{H} to create vHhHvHₖ.
Filter vHhHvHₖ horizontally by h_{H} to create vHhHvHhHₖ.
Iₖ=(vLhLvLhLₖ+vLhHvLhHₖ+vHhLvHhLₖ+vHhHvHhHₖ)/16
   The spatially filtered frame 114 is Iₛ=I₁. A color frame contains three channels: Y, U, V. The spatial filter is applied on each color channel independently.

In addition to accounting for and applying the spatial filter, the noise filter also estimates the noise. The noise estimation contains three steps, which are described herein below.

First is estimating the noise for each block/line. The frame is processed either block-by-block or line-by-line. So we first estimate a noise level Nᵢ for i-th block or line. In one embodiment, one of two methods may be utilized to estimate Nᵢ. One method is based on spatial information and the other is based on temporal information. They can be chosen based on the application.

In Nᵢ estimation based on spatial information, Nᵢ is the mean absolute value of the coefficient array given at the first level of the hierarchical representation.

Nᵢ=mean(|vHhH₁ᵢ|).

vHhH₁ᵢ is the i-th block or line of the coefficient array vHhH₁.

In the Nᵢ estimation based on temporal information, Nᵢ is the mean absolute difference between the input frame I 110 and a reference frame Iₚ 116.

Nᵢ=mean(|Iᵢ−Iₚᵢ|).

Iᵢ is the i-th block or line of the input frame I 110. Iₚᵢ is the i-th block or line of the reference frame Iₚ 116.

Second is estimating noise for a frame. After we have Nᵢ for all i, the noise level of the frame is the mean, or the median, or the minimum of Nᵢ. They can be chosen based on the application.
N=mean(Nᵢ) for all i.
Or N=median(Nᵢ) for all i.
Or N=min(Nᵢ) for all i.

Third, the noise level should change slowly in a video sequence. So a low-pass IIR filter is applied on the noise level. N(n) denotes the noise level of the n-th frame and N_{f}(n) denotes the noise level after the low-pass filtration.

N_{f}(n)=βN_{f}(n−1)+(1−β)N(n).

β is the coefficient of the IIR filter which controls how fast the noise level changes frame-to-frame. The noise estimation is performed on each color channel independently. Each color channel has its own noise level.

There are three steps for the temporal filtration. The temporal filter can also be applied block-by-block or line-by-line, which are motion detection, Motion-to-blending factor conversion and frame blending.

In the Motion detection, the reference frame Iₚ(x,y,n) 116 is the previous output frame stored in the buffer 108.

Iₚ(x,y,n)=Iₒ(x,y,n−1).

The motion value at (x, y) is just the absolute difference between the spatially filtered frame 114 and the reference frame 116 for all three color channels:

m(x,y,n)=|Iₛ_{_{—}}_{Y}(x,y,n)−Iₚ_{_{—}}_{Y}(x,y,n)|+|Iₛ_{_{—}}_{U}(x,y,n)−Iₚ_{_{—}}_{U}(x,y,n)|+|Iₛ_{_{—}}_{V}(x,y,n)−Iₚ_{_{—}}_{V}(x,y,n)|.

Iₛ_{_{—}}_{Y}, Iₛ_{_{—}}_{U}, Iₛ_{_{—}}ᵥ are the three color channels of Iₛ 114 Iₚ_{_{—}}_{Y}, Iₚ_{_{—}}_{U}, Iₚ_{_{—}}_{V} are the three color channels of Iₚ 116.

Since the motion detection is working on the spatially filtered frames Iₛ 114 and the previously filtered frame Iₚ 116, it is much more robust than the motion detection working on original noisy frames.

In the motion-to-blending factor conversion step, if there is little motion, the temporal filtration result is more reliable. If there is large motion, the spatial filtration result is more reliable. FIG. 2 is an embodiment of a blending factor controlled by the motion value. As shown in FIG. 2, a blending factor for each pixel at x, y is defined as:

$$\begin{matrix}α ( x , y , n ) = {α}_{0} + ( 1 - {α}_{0} ) m ( x , y , n ) / {T}_{m} & if m ( x , y , n ) < {T}_{m} , \\ = 1 & else .\end{matrix}$$

Tₘ is an input parameter of the temporal filter. Flat areas look smoother when Tₘ increases. But larger Tₘ causes more “ghosting” artifacts on moving areas. α₀ is the offset of the motion-blending factor function in FIG. 2.

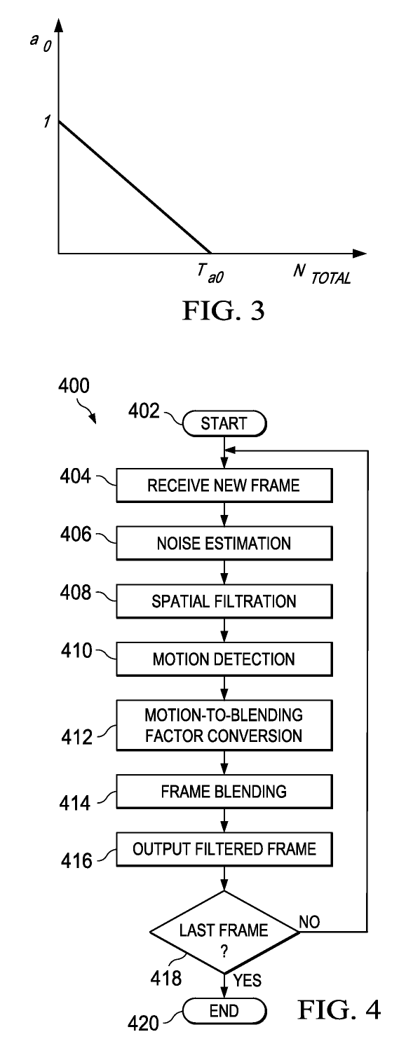

FIG. 3 is an embodiment of an offset α₀ is controlled by the total noise level Nₜₒₜₐₗ. As shown in FIG. 3, it is controlled by the total noise level of the three color channels:

$$\begin{matrix}{α}_{0} = 1 - {N}_{total} / {T}_{α 0} & if & {N}_{total} < {T}_{α 0 ,} \\ = 0 & else . & \end{matrix}$$

Nₜₒₜₐₗ is the total noise level of all the three channels:

Nₜₒₜₐₗ=N_{f}_{_{—}}_{Y}+N_{f}_{_{—U}}+N_{f}_{_{—}}_{V}.

T_{α0} is a register to control the slope of the function in FIG. 3. This function makes α₀ to be close to 1 if the noise level is low, and therefore the temporal filter to be very weak to avoid ghosting artifacts.

In the frame blending, the output frame 112 is an weighted averaging of Iₛ(x,y,n) 114 and Iₚ(x,y,n) 116:

$$\begin{matrix}{I}_{o} ( x , y , n ) = α {I}_{s} ( x , y , n ) + ( 1 - α ) {I}_{o} ( x , y , n - 1 ) , \\ = α {I}_{s} ( x , y , n ) + ( 1 - α ) {I}_{p} ( x , y , n ) .\end{matrix}$$

The spatial filter may or may not be the same as the image filter used. In one embodiment, the horizontal level and vertical level (u and v) may be different. The image filter used may only handle the case when u=v.

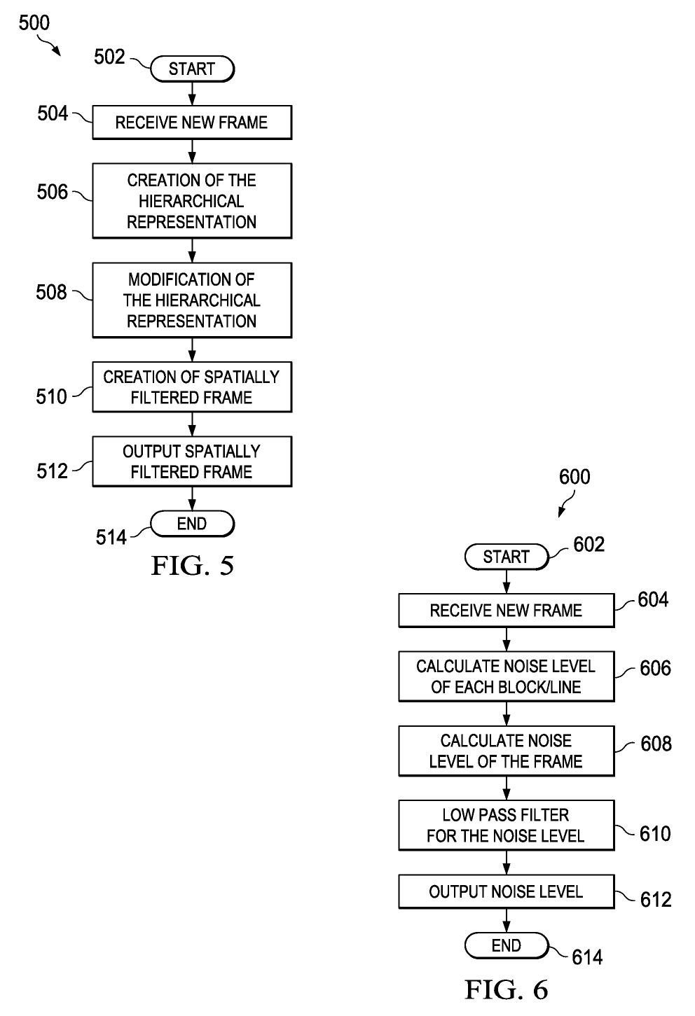

FIG. 4 is a flow diagram depicting an embodiment of a filtering noise method 400 utilizing both spatial filtration and temporal filtration. The method starts at step 402 and proceeds to step 404. At step 404, a new frame is received. At step 406, the method 400 performs a noise estimation, which is better discussed in FIG. 1 and FIG. 6. At step 408, the method 400 performs spatial filtration, which is better described in FIG. 1 and FIG. 5. At step 410, the method performs motion detection, as described in FIG. 1. At step 412, the method 400 performs motion-to-blending factor conversion as described in FIG. 1, FIG. 2 and FIG. 3. At step 414, the method 400 outputs a filtered frame. At step 418, the method 400 determines if the frame processed is the last frame. If the frame is not the last frame, the method 400 proceeds from step 418 to step 404. If there is the last frame, the method 400 ends at step 420.

FIG. 5 is a flow diagram depicting an embodiment of a method 500 for generating a spatially filtered frame. The method starts at step 502 and proceeds to step 504. At step 504, the method receives new frames. At step 506, the method creates hierarchical representation. At step 508, coefficients in k-th level of the created hierarchical representation are modified. At step 510, the method 500 creates a spatially filtered frame. At step 512, a spatially filtered frame is outputted. The method 500 ends at step 514.

FIG. 6 is a flow diagram depicting an embodiment of a method 600 for noise estimation. The method 600 starts at step 602. At step 604, a new frame is received. At step 606, the method 600 calculates noise level of one or more blocks and/or lines. At step 608, the method 600 calculates the noise level of the frame. At step 610, the method 600 applies a low pass filter on the noise level. At step 612, a noise level is outputted. The method 600 ends at step 614.

While the foregoing is directed to embodiments of the present invention, other and further embodiments of the invention may be devised without departing from the basic scope thereof, and the scope thereof is determined by the claims that follow.

What is claimed is:

1. A noise filter method for producing at least one of a video or an image with reduced noise, comprising:
performing noise estimation on a frame of at least one of an image or video and applying a low pass filter on the noise level;
performing spatial filtration on the frame according to the noise estimation;
performing motion detection on a spatially filtered frame;
determining motion-to-blending factor conversion according to the noise estimation and, accordingly, performing frame blending; and
outputting a frame with reduced noise.

2. The noise filter method of claim 1, wherein the step of performing spatial filtration comprises:
creating a hierarchical representation of the frame;
modifying a coefficient in k-th level of the created hierarchical according to the noise estimation; and
producing the spatially filtered frame.

3. The noise filter method of claim 1, wherein the step of estimating noise comprises:
calculating noise level of at least a block or a line;
calculating noise level of the frame; and
applying a low pass filter on the noise level.

4. A computer readable medium comprising computer instructions, which when executed perform a noise filter method for producing at least one of a video or an image with reduced noise, the method comprising:
performing noise estimation on a frame of at least one of an image or video and applying a low pass filter on the noise level;
performing spatial filtration on the frame according to the noise estimation;
performing motion detection on a spatially filtered frame;
determining motion-to-blending factor conversion according to the noise estimation and, accordingly, performing frame blending; and
outputting a frame with reduced noise.

5. The computer readable medium of claim 4, wherein the step of performing spatial filtration of the noise filter method comprises:
creating a hierarchical representation of the frame;
modifying a coefficient in k-th level of the created hierarchical according to the noise estimation; and
producing the spatially filtered frame.

6. The computer readable medium of claim 4, wherein the step of estimating noise of the noise filter method comprises:
calculating noise level of at least a block or a line;
calculating noise level of the frame; and
applying a low pass filter on the noise level.

7. An apparatus, comprising:
means for performing noise estimation on a frame of at least one of an image or video and applying a low pass filter on the noise level;
means for performing spatial filtration on the frame according to the noise estimation;
means for performing motion detection on a spatially filtered frame; and
means for determining motion-to-blending factor conversion according to the noise estimation and, accordingly, performing frame blending.

8. The apparatus of claim 7, wherein the means for performing spatial filtration comprises:
means for creating a hierarchical representation of the frame;
means for modifying a coefficient in k-th level of the created hierarchical according to the noise estimation; and
means for producing the spatially filtered frame.

9. The apparatus of claim 7, wherein the means for estimating noise comprises:
means for calculating noise level of at least a block or a line;
means for calculating noise level of the frame; and
applying a low pass filter on the noise level.
